(19) United States
(12) Patent Application Publication
(10) Pub. No.: US 2009/0174660 A1
(43) Pub. Date: Jul. 9, 2009

(54) AMBIDEXTROUS OPERATED COMPUTER SYSTEM

(75) Inventors: YI-FENG WENG, Shenzhen City (CN); SHIH-FANG WONG, Tu-Cheng (TW); BING LI, Shenzhen City (CN); YONG YUAN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/193,774

(22) Filed: Aug. 19, 2008

(30) Foreign Application Priority Data
Jan. 3, 2008 (CN) 200810300005.0

(51) Int. Cl. G09G 5/08; G06F 3/033

(52) U.S. Cl. 345/163

(57) ABSTRACT

The present invention provides a computer system operable by users of either handedness. The computer system includes a mouse and a computer connected together by interfaces. The mouse generates a mode-setting signal by a mode shift unit shifting between two selectable positions. The computer includes: a storage unit configured for storing a current operation mode of the mouse; a mouse interface configured for connecting the computer to the mouse and receiving the mode-shifting signal from the mouse; a driver unit configured for converting the mode-setting signal into a mode-shifting signal into a format which can be recognized by a central processing unit (CPU) of the computer; and a controller configured for updating the current operation mode in the storage unit from one of the left-handed operation mode and the right-handed mode to another of the two modes.

### BACKGROUND

1. Technical Field

The present invention relates to a computer system, especially to a computer system with a mouse adapted for use by persons either right-handed or left-handed.

2. Description of Related Art

A computer mouse is an input device of a computer. Depending on the configuration of the operating system of the computer, the computer mouse may have one or more operational buttons. A computer mouse with more than one operational buttons generally has a left button and a right button for generating click signals in response to click operations. People usually use the right hand to operate the mouse. Therefore, a default operation mode configured by the operating system is designated for right-handed people. As to left-handed people or people who need to shift the operation mode frequently, it is inconvenient and troublesome to change the operation mode of the mouse in the operating system.

### SUMMARY

An embodiment of the present invention provides a computer system operable by persons either right-handed or left-handed. The computer system includes a mouse capable of shifting operation modes by a button fixed in the mouse, which is convenient for people to switch the mode to operate the mouse either by left hand or by right hand.

The computer system includes a mouse and a computer connected to the mouse. The mouse generates a mode-setting signal by a mode shift unit shifting between two selectable positions. The computer includes: a storage unit configured for storing a current operation mode of the mouse; a mouse interface configured for connecting the computer to the interface of the mouse and receiving the mode-shifting signal from the mouse; a central processing unit (CPU) capable of change the operation modes; a driver unit configured for converting the mode-setting signal into a mode-shifting signal into a format which can be recognized by the CPU of the computer; and a controller configured for updating the current operation mode in the storage unit from one of the left-handed operation mode and the right-handed mode to another of the two modes.

### BRIEF DESCRIPTION OF THE DRAWINGS

FIG. 1 is a planar view of a left/right-hand operated mouse in accordance with a preferred embodiment of the present invention;

FIG. 2 is a block diagram of a hardware infrastructure of the mouse of FIG. 1, together with partial structures in a computer to which the mouse is connected; and

FIG. 3 is a flowchart of a preferred method for shifting an operation mode of the mouse.

### DETAILED DESCRIPTION OF EMBODIMENTS

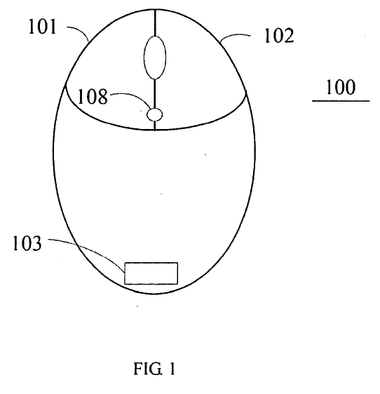

FIG. 1 is a planar view of a left/right-hand operated mouse 100 in accordance with a preferred embodiment of the present invention. The mouse 100 includes a left-button 101, a right-button 102 and a mode shift unit 103. The left-button 101 and the right-button 102 are provided for in response to clicks to the buttons, such as a single-click or a double-click. The mode shift unit 103 includes an adjustable knob or button accessible to the user for inputting a desired shift command. The mode shift unit 103 can be situated in any position on the mouse 100 including the left side, the right side and the rear side of the mouse 100. The adjustable knob or button of the mode shift unit 103 has two selectable positions, namely a left-handed position and a right-hand position correspondingly representing a left-handed mode and a right-handed mode. In one embodiment, the adjustable knob can be turned left and turned right to switch between the two selectable positions. In another embodiment, the adjustable button can be pressed down and released up to and from the two selectable positions.

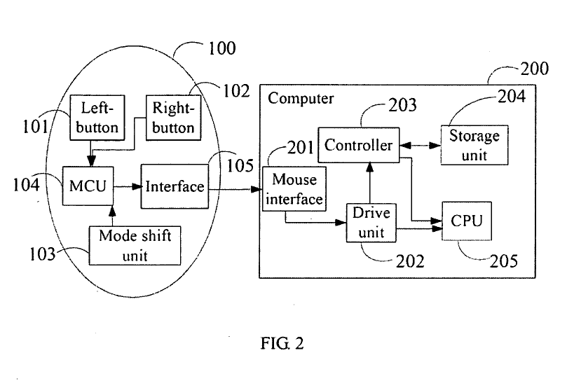

FIG. 2 is a block diagram of a hardware infrastructure of the mouse 100 of FIG. 1, together with partial structures in a computer to which the mouse is connected. The mouse 100 further includes a micro central unit (MCU) 104 and an interface 105 for connecting with the computer 200. The interface 105 can be either one of the followings: a universal serial bus (USB), a wireless interface, a BLUETOOTH interface, a PS/2 interface, and so on. The MCU 104 is configured to generate: 1) a left-button signal in response to a click from the left-button 101; 2) a right-button signal in response to a click from the right-button 102; and 3) a mode-setting signal in response to a position shifting of the adjustable knob or button of the mode shift unit 103. The MCU 104 transmits all of the left-button signal, the right-button signal, and the mode-setting signal to the computer 200 via the interface 105.

The computer 200 includes a mouse interface 201, a driver unit 202, a controller 203, a storage unit 204 and a central processing unit (CPU) 205. The storage unit 204 is configured for storing a current operation mode of the mouse 100. The current operation mode of the mouse 100 is either the left-handed mode or the right-handed mode. The driver unit 202 is configured for obtaining the left-button signal and the right-button signal from the mouse 100 via the connection of the interface 105 and the mouse interface 201, and transmitting those signals to the CPU 205. The CPU 205 executes functions corresponding to the left-button signal and the right-button signal based on the current operation mode. The driver unit 202 is further configured for obtaining the mode-shifting signal from the mouse interface 201. The driver unit 202 converts the mode-shifting signal into a format so that the converted mode-shifting signal can be recognized by the CPU 205. The driver unit 202 further transmits the converted mode-shifting signal to the controller 203. The controller 203 updates the current operation mode stored in the storage unit 204 according to the mode-shifting signal.

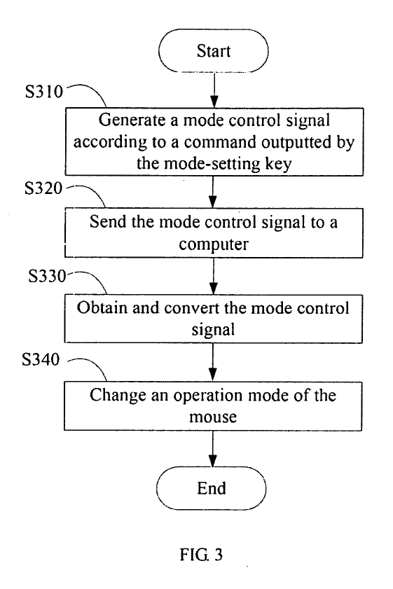

FIG. 3 is a flowchart of a preferred method for shifting the current operation mode of the mouse 100.

In step S310, The MCU 104 of the mouse 100 generates a mode-setting signal according to a position shifting exerted on the adjustable knob or button of the mode shift unit 103.

In step S320, the interface 105 of the mouse 100 receives and sends the mode-setting signal to the computer 200.

In step S330, the driver unit 202 of the computer 200 obtains and converts format of the mode-shifting signal so that the converted mode-shifting signal can be recognized by the controller 203.

In step S340, change the mouse operation mode, and the controller 203 updates the current operation mode of the mouse 100 stored in the storage unit 204 according to the mode-shifting signal.

In other embodiments under the soul of the present invention, the mouse 100 can further includes an indicating lamp 108. The MCU 104 turns on or turns off the indicating lamp according to whether the current operation mode of the mouse 100 is in the left-handed mode or in the right-handed mode. For example, the turning on lamp 108 indicates the left-handed mode, and the turning off lamp 108 indicates the right-handed mode.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A computer system operable by persons either right-handed or left-handed, comprising a mouse and a computer connected to the mouse, the mouse comprising:
a mode shift unit having two selectable positions, one of which is a left-handed position representing a left-handed mode and another is a right-hand operation position representing a right-handed operation mode;
a microcontroller unit (MCU) configured for generating the mode-shifting signal in response to a position shifting of the mode shift unit between the two selectable positions; and
an interface configured for connecting the mouse to a computer and transmitting the mode-shifting signal to the computer; and
the computer comprising:
a storage unit configured for storing a current operation mode of the mouse, the current operation mode being one of a left-handed operation mode or a right-handed operation mode;
a mouse interface configured for connecting the computer to the mouse and receiving the mode-shifting signal from the mouse;
a central processing unit (CPU) capable of change the operation modes;
a driver unit configured for converting the mode-shifting signal into a format which can be recognized by the CPU of the computer; and
a controller configured for updating the current operation mode in the storage unit from one of the left-handed operation mode and the right-handed mode to another of the two modes.

2. The computer system according to claim 1, wherein the mouse further comprises a left-button and a right-button, the MCU is further configured for generating a left-button signal in response to a click from the left-button and generating a right-button signal in response to a click from the right-button, the MCU further is further configured for transmitting the left-button signal and the right-button signal to the computer via the interfaces.

3. The computer system according to claim 2, wherein the driver unit is further configured for obtaining the left-button signal and the right-button signal from the mouse.

4. The computer system according to claim 3, wherein the CPU is further configured for executing functions corresponding to the left-button signal and the right-button signal transmitted from the driver unit based on the current operation mode.

5. The computer system according to claim 1, wherein the mode shift unit is a button which can be pressed down and released up to switch between the two selectable positions.

6. The computer system according to claim 1, wherein the mode shift unit is a knob which can be turned left and turned right to switch between the two selectable positions.

7. The computer system according to claim 1, wherein the mouse further comprises a indicating lamp controlled by the MCU and capable of turning on or turning off for indicating the left-handed operation mode or the right-handed operation mode.

9. A mouse capable of shifting operation modes, comprising:
a mode shift unit having two selectable positions of which a left-handed position representing a left handed operation mode of the mouse and a right-hand position representing a right-handed operation mode of the mouse;
a microcontroller unit (MCU) configured for generating the mode-shifting signal in response to a position shifting of the mode shift unit between the two selectable positions; and
an interface configured for connecting the mouse to an external computer and transmitting the mode-shifting signal to the computer.

10. The mouse according to claim 9, further comprising a left-button and a right-button, the MCU being further configured for generating a left-button signal in response to a click from the left-button and generating a right-button signal in response to a click from the right-button; the MCU being further configured for transmitting the left-button signal and the right-button signal to the computer via the interface.

11. The mouse according to claim 9, wherein the mode shift unit is a button which can be pressed down and released up to and from the two selectable positions.

12. The mouse according to claim 9, wherein the mode shift unit is a knob which can be turned left and turned right to and from the two selectable positions.

13. The mouse according to claim 9, further comprising a indicating lamp being capable of turning on or turning off for indicating the left-handed operation mode or the right-handed operation mode.

14. The mouse according to claim 9, wherein the interface is one selected from the group consisting of a universal serial bus interface, a wireless interface, a BLUETOOTH interface and a PS/2 interface.

15. A method for shifting the current operation mode of a mouse, comprising:
generating a mode control signal according to a command outputted by a mode-setting unit;
sending the mode control signal to a computer;
obtaining and converting the mode control signal by the computer; and
changing the current operation control of the mouse using the computer.

16. The method according to claim 15, further comprising updating the current operation mode in a storage unit by the computer.

17. The method according to claim 15, further comprising saving and updating the current operation mode in a storage unit by the computer.

18. The method according to claim 15, wherein the operation mode is one selected from the group consisting of right-handed operation mode and right-handed operation mode.
